(19) United States
(12) Patent Application Publication
(10) Pub. No.: US 2025/0289746 A1
(43) Pub. Date: Sep. 18, 2025

(54) GLASS MANUFACTURING APPARATUS AND METHODS OF MAKING A GLASS RIBBON

(71) Applicant: CORNING INCORPORATED, CORNING, NY (US)

(72) Inventors: Tomohiro Aburada, Painted Post, NY (US); Kaushik Arumbuliyur Comandur, Birmingham (GB); Allan Mark Fredholm, Vulaines sur Seine (FR); Justin Shane Starkey, Painted Post, NY (US); Brandon Thomas Sternquist, Corning, NY (US); Steven Howard Tarcza, Painted Post, NY (US); Dailin Wang, Painted Post, NY (US); Yifei Wang, Avon (FR); Rui Zhang, Corning, NY (US)

(21) Appl. No.: 18/860,110

(22) PCT Filed: Apr. 26, 2023
(86) PCT No.: PCT/US2023/019891

§ 371 Date: Oct. 25, 2024

Related U.S. Application Data
(60) Provisional application No. 63/338,163, filed on May 4, 2022.

(51) Int. Cl. C03B 17/06

(52) U.S. Cl. CPC C03B 17/067; C03B 17/064; C03B 17/068

(57) ABSTRACT

Glass manufacturing apparatus comprise a forming device configured to deliver a stream of molten material along a first axis. The first roller is configured to direct the stream of molten material to flow off one side of the first roller and travel along a second axis that is within 20% of a radius of the first roller from the first axis. The first axis intersects a guide member positioned downstream from the first roller. The second axis does not intersect the guide member. Methods comprise contacting a first roller with a stream of molten material traveling along a first axis. Methods comprise directing the stream of molten material to flow off one side of the first roller and travel along a second axis. A distance between the first axis and the second axis is within 20% of the radius of the first roller.

### CROSS REFERENCE TO RELATED APPLICATION

This application claims the benefit of priority under 35 U.S.C. § 119 of U.S. Provisional Application Ser. No. 63/338,163 filed on May 4, 2022, the content of which is relied upon and incorporated herein by reference in its entirety.

### FIELD

The present disclosure relates generally to glass manufacturing apparatus and methods of making a glass ribbon and, more particularly, to methods of manufacturing a glass ribbon comprising cooling molten material to form a glass ribbon.

### BACKGROUND

Glass sheets can be used in photovoltaic applications or display applications, for example, liquid crystal displays (LCDs), electrophoretic displays (EPDs), organic light-emitting diode displays (OLEDs), and plasma display panels (PDPs). Glass sheets are commonly fabricated by flowing molten material to a forming device whereby a glass ribbon may be formed by a variety of web forming processes, for example, slot draw, float, down-draw, fusion down-draw, rolling, tube drawing, or up-draw. The glass web may be periodically separated into individual glass sheets.

However, the use of such methods for forming glass ribbons can be limited when using a molten material having a low devitrification viscosity and/or a high devitrification temperature. Consequently, there is a need for methods of manufacturing a glass ribbon that can be used with a molten material having a low devitrification viscosity and/or a high devitrification temperature.

### SUMMARY

The following presents a simplified summary of the disclosure to provide a basic understanding of some aspects described in the detailed description. Aspects of the disclosure provide a guide member configured to cool a stream of molten material. An extent of cooling can be controlled by adjusting a distance between the guide member and the stream of molten material or an orientation of the guide member. Flowing a cooling fluid through the guide member can maintain a temperature at a surface of the guide member, which can effectively cool the stream of molten material. Also, the guide member can comprise a pair of guide members positioned on opposite sides of the stream of molten material, which can evenly cool and effectively cool the stream of molten material. Effectively cooling the stream of molten material can reduce the time and/or space required for the stream of molten material to sufficiently cool such that it can be handled, for example, using pull rollers. Effectively cooling the stream of molten material can enable the use of a stream of molten material comprising a lower viscosity (e.g., about 5,000 Pascal-seconds or less, about 1,000 Pascal-seconds or less) when the stream of molten material leaves a delivery device, for example, the use of molten material comprising a low devitrification viscosity and/or a high devitrification temperature to form a glass ribbon.

Aspects of the disclosure provide a first roller positioned between a delivery device and the guide member, where the first roller is configured to direct the stream off one side of the first roller. The first roller can be configured to cool the stream of molten material. In combination with the guide member, the first roller can further effectively cool the stream of molten material. Providing the guide member between the first roller and the pair of pull rollers can catch and/or redirect any portion of the stream of molten material that deviates from a second axis that the stream of molten material is configured to travel along during normal operation, which can prevent damage from such portion of the stream of molten material to other equipment in the glass manufacturing apparatus. When the guide member comprises a pair of guide members positioned on opposite sides of the stream of molten material, a distance between the pair of guide members can be adjusted, for example, such that the stream of molten material is formed into an intermediate ribbon of molten material by the pair of guide members (e.g., pair of guide rollers). Forming an intermediate ribbon of molten material can reduce deviations of any portion of the molten material from the second axis and/or increase a distance that the molten material (e.g., stream, ribbon) can travel without being destabilized. Further, the distance between a pair of guide rollers can form a pool of molten material above a nip between the pair of guide rollers, which can produce a stable and/or uniform intermediate ribbon of molten material. When the stream of molten material contacts a guide member, sticking of molten material to the guide member can be mitigated by maintaining a low temperature (e.g., about 200° C. or less) at a surface of the guide member.

During a process upset, for example when the first roller is temporarily removed and/or being replaced, the stream of molten material can travel along a first axis rather than a second axis. Providing the guide member can redirect the stream of molten material to travel along a third axis that is closer to the second axis than the first axis is to the second axis, which reduces the deviation of the stream of molten material from the second axis. For example, the third axis can impinge a portion of the pull rollers, where the pull rollers can direct material traveling along the third axis to travel between a pair of pull rollers (e.g., along the second process). Reducing the deviation of the stream of molten material can reduce damage to other equipment in the glass manufacturing apparatus. Reducing the deviation of the stream of molten material can allow the molten material to travel through subsequent parts of the glass manufacturing apparatus to produce a glass ribbon even during a process upset. When the guide member comprises at least one guide roller, rotating the at least one guide roller can reduce scattering of molten material, which reduces the risk of damage to other equipment and increases an efficiency of the method of making a glass ribbon.

In aspects, a glass manufacturing apparatus comprises a forming device configured to deliver a stream of molten material to a first roller along a first axis extending in a direction of gravity. The glass manufacturing apparatus comprises the first roller positioned downstream from the forming device and configured to direct the stream of molten material to flow off one side of the first roller to travel along a second axis extending in the direction of gravity and spaced a first distance within 20% of a radius of the first roller from the first axis. The glass manufacturing apparatus comprises a guide member positioned downstream from the first roller. The first axis intersects the guide member. The second axis does not intersect the guide member.

In further aspects, the glass manufacturing apparatus further comprises a pair of driven pull rollers positioned downstream from the guide member. The second axis passes between the pair of driven pull rollers.

In further aspects, the guide member comprises at least one guide roller and a second distance between the first axis and a radial center of the at least one guide roller is 120% of the radius of the first roller or less.

In even further aspects, the first roller is configured to receive a flow of cooling fluid therethrough.

In even further aspects, the at least one guide roller is rotatable about an axis of rotation and coupled to a motor such that an upper peripheral portion of the at least one guide roller rotates toward the second axis when the at least one guide roller is rotated by the motor.

In even further aspects, a radius of the at least one guide roller is in a range from about 3 centimeters to about 10 centimeters.

In even further aspects, a distance along the second axis between a radial center of the first roller and the radial center of the at least one guide roller is in a range from about 10 centimeters to about 50 centimeters.

In even further aspects, the at least one guide roller comprises a pair of guide rollers, the second axis passing between the pair of guide rollers.

In still further aspects, a minimum distance between peripheral surfaces of the pair of guide rollers is adjustable.

In further aspects, the guide member comprises a contact surface that is downwardly inclined in the direction of gravity toward the second axis.

In even further aspects, the contact surface comprises a flat contact surface extending along a plane. The plane of the flat contact surface intersects the second axis at an inclination angle in a range from about 5° to about 45°.

In still further aspects, the inclination angle of the contact surface is adjustable.

In aspects, a method of forming a glass ribbon comprising contacting a first roller with a stream of molten material from a forming device. The stream of molten material comprising a first viscosity in a range from about 10 Pascal-seconds to about 5,000 Pascal-seconds when the stream of molten material leaves the forming device. The stream of molten material traveling along a first axis extending in a direction of gravity from the forming device to the first roller. Methods comprise directing the stream of molten material with the first roller to flow off one side of the first roller and travel along a second axis extending in the direction of gravity. A first distance between the first axis and the second axis is within 20% of a radius of the first roller. Methods comprise cooling the stream of molten material with a guide member.

In further aspects, directing the stream of molten material comprises directing the entire stream of molten material to travel off the one side of the first roller.

In further aspects, the first viscosity is in a range from about 100 Pascal-seconds to about 1,000 Pascal-seconds.

In further aspects, after cooling the stream of molten material with the guide member, the method further comprises passing the stream of molten material between a pair of driven pull rollers to form a ribbon of molten material. The method further comprises cooling the ribbon of molten material to form the glass ribbon.

In even further aspects, the stream of molten material passing between the pair of driven pull rollers comprises a second viscosity in a range from about 104 Pascal-seconds to about 10⁶ Pascal-seconds.

In further aspects, the method further comprises maintaining the guide member at a temperature of about 200° C. or less during the cooling.

In further aspects, the method further comprises moving the first roller out of contact with the stream of molten material such that the stream of molten material travels along the first axis to the guide member and the guide member directs the stream of molten material to travel along a third axis in the direction of gravity. A fourth distance between the third axis and the second axis is less than 120% of the radius of the first roller.

In even further aspects, the guide member comprises at least one guide roller. The at least one guide roller comprising a peripheral surface. The at least one guide roller is maintained at the temperature by flowing a cooling fluid within the at least one guide roller.

In still further aspects, the method comprising rotating the at least one guide roller such that an upper peripheral portion of the at least one guide roller rotates toward the second axis.

In still further aspects, the at least one guide roller comprises a pair of guide rollers. The stream of molten material passes between the pair of guide rollers to form an intermediate ribbon of molten material comprising a thickness substantially equal to a nip distance of a nip area between corresponding peripheral surfaces of the pair of guide rollers.

In yet further aspects, the stream of molten material forms a pool of molten material supported by the pair of guide rollers above the nip area. Molten material is drawn from the pool of molten material through the nip area to form the intermediate ribbon of molten material.

In still further aspects, methods further comprise adjusting a distance between the stream of molten material and the peripheral surface of the at least one guide roller to adjust the cooling of the stream of molten material.

In even further aspects, the guide member comprises at least one inclined plate. The method further comprises flowing a cooling fluid within the at least one inclined plate.

In still further aspects, the at least one inclined plate comprises a flat contact surface downwardly inclined in the direction of gravity toward the second axis and extending along a plane that intersects the second axis at an inclination angle in a range from about 5° to about 45°.

In yet further aspects, the method further comprises adjusting the inclination angle of the at least one inclined plate to adjust the cooling the stream of molten material.

In still further aspects, the guide member comprises a pair of inclined plates, and the stream of molten material passes between the pair of inclined plates.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects, and advantages are better understood when the following detailed description is read with reference to the accompanying drawings, in which:

FIG. 1 schematically illustrates an exemplary embodiment of a glass manufacturing apparatus in accordance with aspects of the disclosure; and

FIG. 2 illustrates a schematic cross-sectional side view of a glass manufacturing apparatus taken along line 2-2 of FIG. 1 comprising a pair of guide rollers and a first roller in accordance with aspects of the disclosure;

FIG. 3 illustrates a schematic cross-sectional side of a glass manufacturing apparatus taken along line 2-2 of FIG. 1 comprising a pair of guide rollers forming a pool of molten material in accordance with aspects of the disclosure;

FIG. 4 illustrates a schematic cross-sectional side of a glass manufacturing apparatus taken along line 2-2 of FIG. 1 comprising a pair of inclined plates and the first roller in accordance with aspects of the disclosure;

FIG. 5 illustrates a schematic cross-sectional side of a glass manufacturing apparatus taken along line 2-2 of FIG. 1 comprising a pair of guide rollers when the first roller does not contact the stream of molten material in accordance with aspects of the disclosure; and

FIG. 6 illustrates a schematic cross-sectional side of a glass manufacturing apparatus taken along line 2-2 of FIG. 1 comprising a pair of inclined plates when the first roller does not contact the stream of molten material in accordance with aspects of the disclosure.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which exemplary aspects are shown. Whenever possible, the same reference numerals are used throughout the drawings to refer to the same or like parts. However, this disclosure may be embodied in many different forms and should not be construed as limited to the aspects set forth herein.

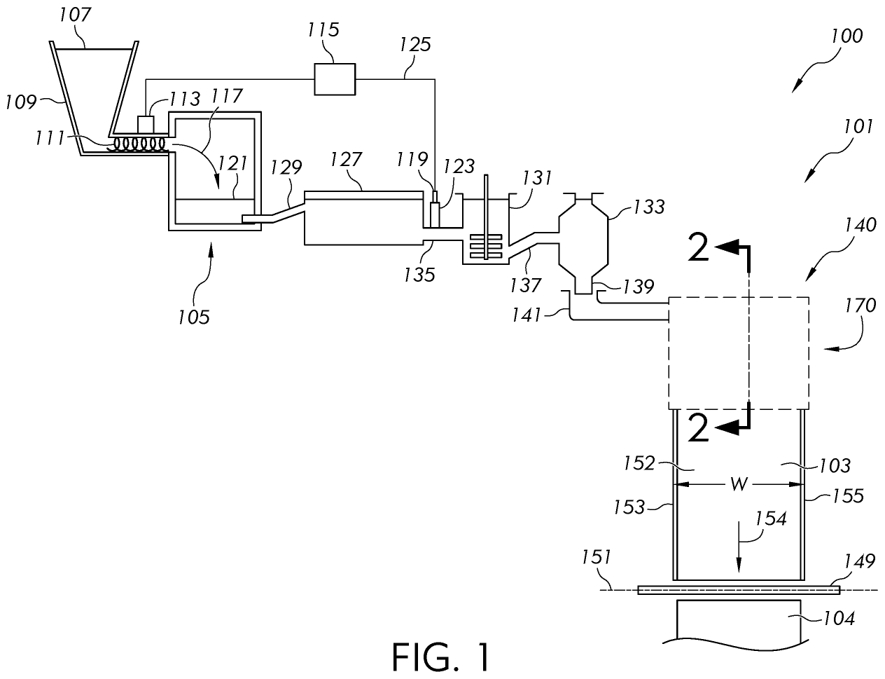

The present disclosure relates to methods for manufacturing a glass ribbon that can use glass manufacturing apparatus and may be employed in methods for manufacturing a glass ribbon from a stream of molten material. For example, FIGS. 1-6 illustrate a glass manufacturing apparatus comprising a down-draw apparatus (e.g., press rolling, slot draw) in the context of manufacturing a glass ribbon from a stream of molten material. Unless otherwise noted, a discussion of features of aspects of the glass manufacturing apparatus can apply equally to corresponding features of other forming apparatuses used in the production of a glass ribbon, for example, glass articles or glass-ceramic articles. Examples of drown-draw glass-forming apparatuses include a slot draw apparatus, press-rolling apparatus, or other glass manufacturing apparatus that can be used as the delivery device to form a glass ribbon from a stream of molten material. In aspects, a glass ribbon from any of these processes may then be divided to provide a plurality of glass ribbons suitable for further processing into an electronic device. For example, separated glass ribbons can be used in a wide range of applications comprising liquid crystal displays (LCDs), electrophoretic displays (EPDs), organic light-emitting diode displays (OLEDs), plasma display panels (PDPs), touch sensors, photovoltaics, appliances (e.g., stovetops), or the like. Such displays can be incorporated, for example, into mobile phones, tablets, laptops, watches, wearables and/or touch-capable monitors or displays.

As schematically illustrated in FIG. 1, an exemplary glass manufacturing apparatus 100 comprises a glass-forming apparatus 101 including a forming device 140 designed to produce a glass ribbon 103 from a stream of molten material 121. As used herein, “molten material” refers to material that can be cooled into glass (i.e., a glass ribbon). In aspects, the molten material can be free of lithia or not and can comprise a silicate, a borosilicate, an aluminosilicate, an aluminoborosilicate, or a soda lime-based composition. As shown, the glass ribbon 103 can comprise a central portion 152 disposed between opposing edge beads formed along a first outer edge 153 and a second outer edge 155 of the glass ribbon 103. Additionally, a glass sheet 104 can be separated from the glass ribbon 103 along a separation path 151 by a glass separator 149 (e.g., scribe, score wheel, diamond tip, laser). Before or after separation of the glass sheet 104 from the glass ribbon 103, the edge beads formed along the first outer edge 153 and the second outer edge 155 can be removed, if present, to provide the central portion 152 as a glass sheet 104 having a more uniform thickness.

The glass ribbon 103 and/or the glass sheet 104 can be formed into a glass or ceramic article. As used herein, “glass” refers to an amorphous material comprising at least 30 mole percent (mol %) of silica (SiO₂). Amorphous materials (e.g., glass) may be strengthened. As used herein, the term “strengthened” may refer to a material that has been chemically strengthened, for example, through ion exchange of larger ions for smaller ions in the surface of the sheet. However, other strengthening methods, for example, thermal tempering, or utilizing a mismatch of the coefficient of thermal expansion between portions of the sheet to create compressive stress and central tension regions, may be utilized to form strengthened sheets. Exemplary glass materials, which may be free of lithia or not, can comprise soda-lime glass, alkali aluminosilicate glass, alkali-containing borosilicate glass, alkali-containing aluminoborosilicate glass, alkali-containing phosphosilicate glass, and alkali-containing aluminophosphosilicate glass. Glass materials can comprise an alkali-containing glass or an alkali-free glass, either of which may be free of lithia or not. In aspects, the glass material can be alkali-free and/or comprise a low content of alkali metals (e.g., R₂O of about 10 mol % or less, wherein R₂O comprises at least one of Li₂O Na₂O, or K₂O).

As used herein, “ceramic” refers to a crystalline phase. A ceramic sheet comprises one or more crystalline phase(s) constituting at least a combined 50 wt % of the ceramic sheet. Ceramic materials may be strengthened (e.g., chemically strengthened). In aspects, a ceramic material can be formed by heating a substrate comprising a glass material to form ceramic (e.g., crystalline) portions. In further aspects, ceramic materials may comprise one or more nucleating agents that can facilitate the formation of crystalline phase(s). In aspects, the ceramic materials can comprise one or more oxides, nitrides, oxynitrides, carbides, borides, and/or silicides.

As shown in FIG. 1, the glass manufacturing apparatus 100 comprises a melting vessel 105 oriented to receive batch material 107 from a storage bin 109. The batch material 107 is introduced by a batch delivery device 111 powered by a motor 113. A controller 115 can optionally be operated to activate the motor 113 to introduce an amount of batch material 107 into the melting vessel 105, as indicated by arrow 117. The melting vessel 105 heats the batch material 107 to provide molten material 121. In aspects, a glass melt probe 119 may be employed to measure a level of molten material 121 within a standpipe 123 and communicate the measured information to the controller 115 by a communication line 125. The glass manufacturing apparatus 100 may comprise a fining vessel 127 located downstream from the melting vessel 105 and coupled to the melting vessel 105 by a first connecting conduit 129. Bubbles can be removed from the molten material 121 within the fining vessel 127. The glass manufacturing apparatus 100 may further comprise a mixing chamber 131 that is located downstream from the fining vessel 127. The mixing chamber 131 can reduce inhomogeneity in the molten material 121 exiting the fining vessel 127. Additionally, the glass manufacturing apparatus 100 can comprise a delivery vessel 133 located downstream from the mixing chamber 131. The delivery vessel 133 conditions the molten material 121 to be fed into an inlet conduit 141. For example, the delivery vessel 133 can function as an accumulator and/or flow controller to adjust and provide a consistent flow of molten material 121 to the inlet conduit 141. In aspects, gravity can drive the molten material 121 through the glass manufacturing apparatus 100, for example, through a first connecting conduit 129 from the melting vessel 105 to the fining vessel 127, through a second connecting conduit 135 from the fining vessel 127 to the mixing chamber 131, and/or through a third connecting conduit 137 from the mixing chamber 131 to the delivery vessel 133. As shown, a delivery pipe 139 is positioned to deliver molten material 121 to the inlet conduit 141 of the forming device 140.

Various forming devices can be provided in accordance with features of the disclosure including a forming device with a wedge for fusion drawing the glass ribbon, a forming device with a slot to slot draw the glass ribbon, or a forming device provided with press rollers to press roll the glass ribbon from the forming device. The molten material 121 delivered to the forming device 140 is formed into the glass ribbon 103 based at least in part on the structure of the forming device 140. In aspects, the width “W” of the glass ribbon 103 is defined between the first outer edge 153 of the glass ribbon 103 and the second outer edge 155 of the glass ribbon 103. In aspects, the width “W” of the glass ribbon 103 can range from about 20 mm to about 4,000 mm, from about 100 mm to about 3,500 mm, from about 500 mm to about 3,000 mm, from about 1,000 mm to about 2,500 mm, or any ranges or subranges therebetween.

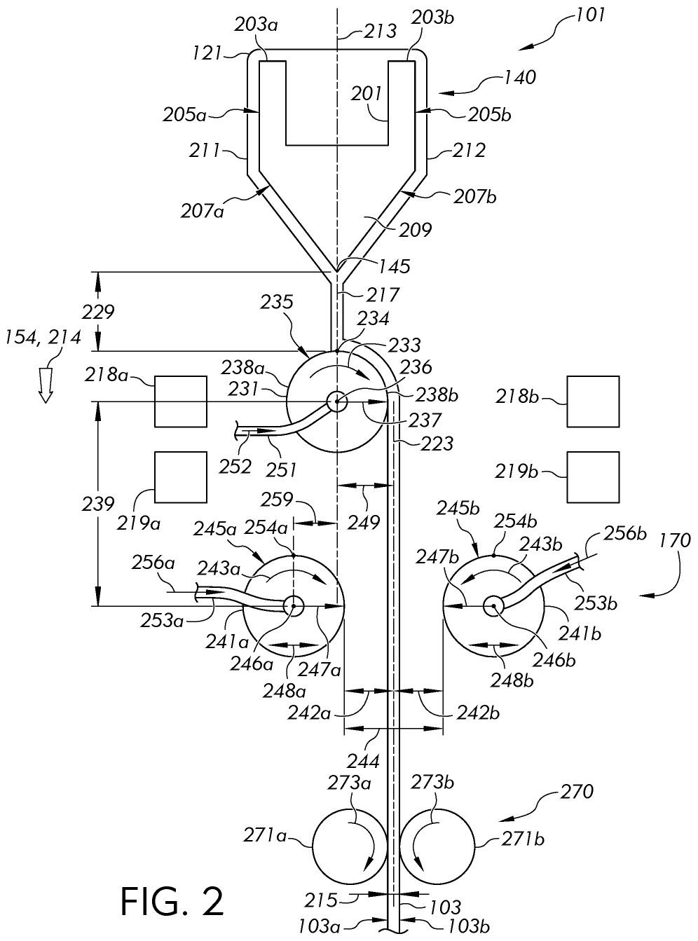

FIGS. 2-6 schematically illustrate cross-sectional views taken along line 2-2 of FIG. 1 of exemplary aspects of the glass manufacturing apparatus 100 including the glass-forming apparatus 101 comprising the forming device 140. As shown, the forming device 140 comprises a trough 201 configured to receive the molten material 121 from the inlet conduit 141 (see FIG. 1). The forming device 140 further comprises a forming wedge 209 including a pair of downwardly inclined converging surface portions 207a, 207b extending between opposed ends of the forming wedge 209 that can converge along a travel direction 154 to intersect along a bottom edge of the forming wedge 209 to define the root 145 of the forming device 140. The molten material 121 delivered to the trough 201 overflows from the trough 201 by simultaneously flowing over weirs 203a and 203b and downward over the outer surfaces 205a and 205b of the weirs 203a and 203b and the corresponding downwardly inclined converging surface portions 207a and 207b of the forming wedge 209 as respective streams 211 and 212 of molten material 121, which can converge and fuse into a stream 217 of molten material 121 at the root 145 of the forming device 140.

As shown in FIGS. 2-6, the forming device 140 is configured to deliver the stream 217 of molten material 121 to travel along a first axis 213 in the travel direction 154. As shown, the first axis 213 can intersect the root 145 of the forming wedge 209. In aspects, as shown, the first axis 213 can extend in a direction 214 of gravity, and/or the travel direction 154 can be coincident with the direction 214 of gravity. As shown in FIGS. 2-4, the forming device 140 is configured to deliver the stream 217 of molten material 121 to a first roller 231 along the first axis 213. As used herein, “downstream” is a relative indication of position along a travel path of the molten material in the travel direction 154. For example, as shown in FIGS. 2-4, the first roller 231 is positioned downstream from the forming device 140 because molten material 121 traveling along a travel path (e.g., along the first axis 213 between the root 145 and the first roller 231) in the travel direction 154 go from the forming device 140 to the first roller 231. A distance 229 (i.e., minimum distance) between the forming device 140 (e.g., the root 145) and a peripheral surface 235 of the first roller 231 along the travel direction 154 can be adjusted to maintain a stability of the stream 217 of molten material. As used herein, the stability of a stream of molten material refers to the ability of the stream to maintain a constant cross-section (i.e., in a plane perpendicular to the direction of gravity, in a plane perpendicular to the travel direction) as the stream travels in the travel direction. Without wishing to be bound by theory, a stream of molten material with low stability can exhibit the Plateau-Rayleigh instability by separating into smaller, non-continuous packets of molten material that tend towards spherical or teardrop droplet shapes. Without wishing to be bound by theory, a maximum distance that a stream of molten material can maintain stability is a function of the viscosity of the stream of molten material and a flow rate of the stream of molten material per width of the stream. For example, the distance 229 can range from about 1 centimeter(cm) to about 20 cm, from about 2 cm to about 10 cm, from about 3 cm to about 8 cm, from about 3 cm to about 5 cm, or any range or subrange therebetween. In aspects, a flow rate of the stream 217 of molten material 121 per unit width “W” of the resulting glass ribbon 103 can range from about 0.1 kilograms per hour per mm width (kg/h mm) to about 5 kg/h mm, from about 0.15 kg/h mm to about 2 kg/h mm, from about 0.2 kg/h mm to about 1.5 kg/h mm, from about 0.5 kg/h mm to about 1 kg/h mm, or any range or subrange therebetween.

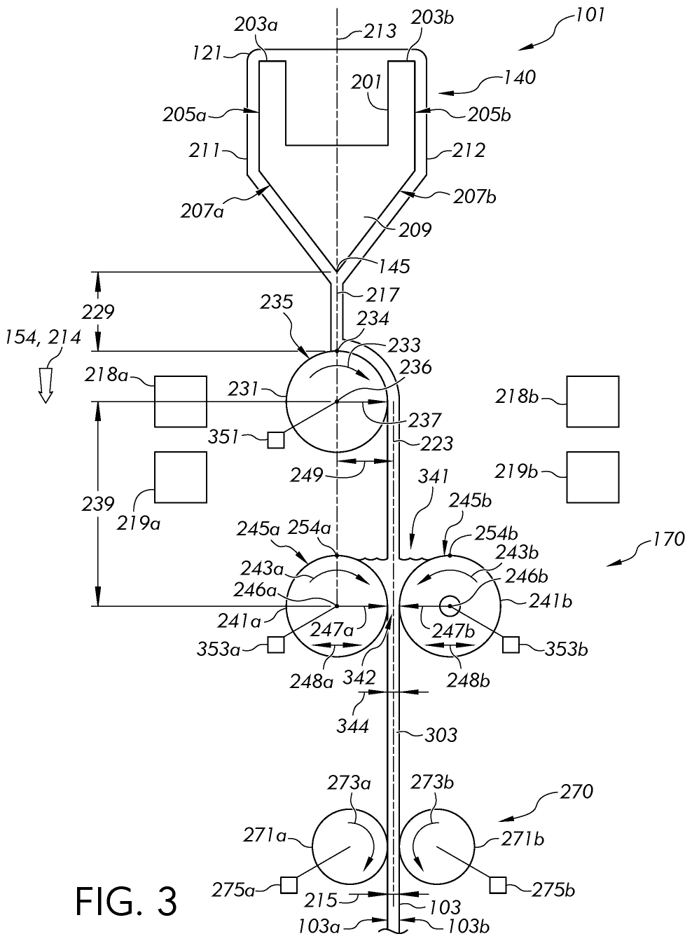

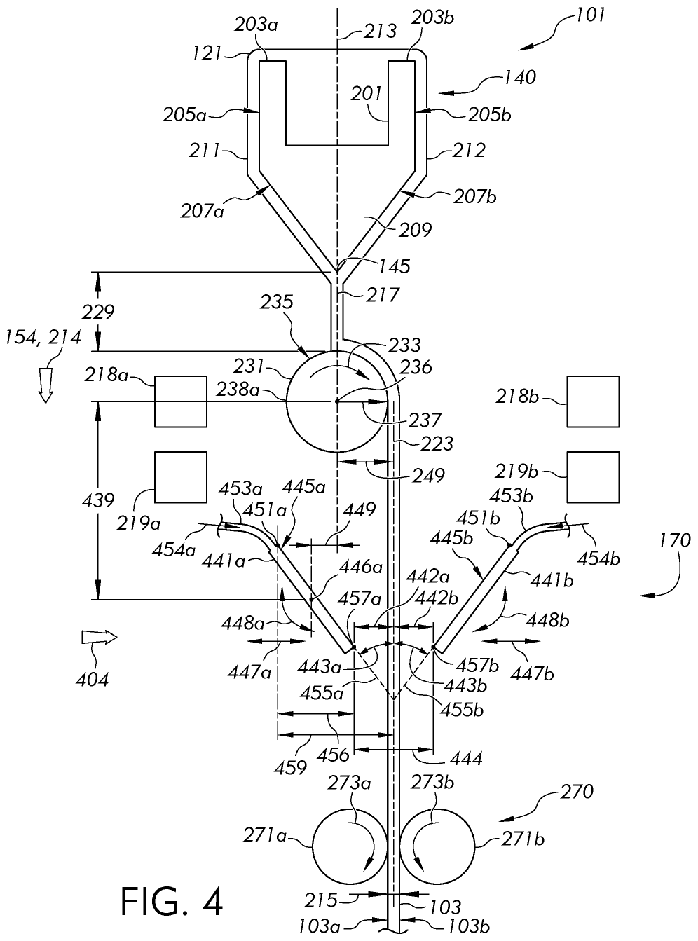

The first roller 231 can be configured to cool the stream 217 of molten material 121. In aspects, as shown in FIG. 2, the first roller 231 can be configured to receive a cooling fluid (as indicated by arrow 252) therethrough, for example, from a conduit 251. Flowing a cooling fluid within the first roller 231 can maintain and/or increase cooling of the stream 217 of molten material 121. In further aspects, the cooling fluid can comprise a liquid, for example water, or a gas, for example air or nitrogen, or a material that transforms from a gas to a liquid while cooling the first roller 231, for example steam, ammonia, or a commercial refrigerant. Although not shown in FIGS. 3-4, the cooling fluid can be used to cool the first roller 231 as shown in FIG. 2. As shown in FIGS. 2-4, the first roller 231 can be configured to rotate in the direction 233 (e.g., clockwise in the illustrated side views) to direct the stream 217 of molten material 121 contacting the peripheral surface 235 of the first roller 231 to flow off one side 238b of the first roller 231 whereupon the stream 217 of molten material 121 travels along a second axis 223 in the travel direction 154. In aspects, as shown, the first roller 231 can be configured to direct the entire stream 217 of molten material 121 off the one side 238b of the first roller 231 (i.e., without directing molten material off the other side 238a opposite the one side 238b). As shown, in FIGS. 2-3, the first roller 231 is configured to rotate such that an upper peripheral portion 234 of the first roller 231 rotates in the direction 233 towards the second axis 223. As shown in FIG. 3, the first roller 231 can be similarly coupled to a motor 351 that rotates the first roller 231 in the direction 233, for example, at a constant speed or a variable speed. Although not shown in FIGS. 2 and 4, the first roller can be coupled to a motor as shown in FIG. 3.

In aspects, as shown, the second axis 223 is parallel to the first axis 213, and/or the second axis 223 extends in the direction 214 of gravity (e.g., coincident with the direction 214 of gravity) and/or the travel direction 154. A second distance 249 (i.e., minimum distance) between the first axis 213 and the second axis 223 can be within 20% of the first radius 237 of the first roller. Throughout the disclosure “within X % of the first radius” means that the distance is in a range from the first radius minus X % of the first radius and the first radius plus X % of the first radius (i.e., from 100−X % of the first radius to 100+X % of the first radius). In further aspects, the second distance can be within 20% of the first radius 237 or less, within 15% of the first radius 237 or less, about 10% of the first radius 237 or less, within 8% of the first radius 237 or less, within 5% of the first radius 237 or less, within 2% of the first radius 237 or less, or within 1% of the first radius 237 or less. In further aspects, the second distance 249 can be within 5 mm or less, 3 mm or less, 2 mm or less, about 1 mm or less, or about 0.5 mm or less of the first radius 237. In aspects, the first radius 237 of the first roller 231 can be about 3 cm or more, about 5 cm or more, about 10 cm or less, or about 8 cm or less, for example, ranging from about 3 cm to about 10 cm, from about 5 cm to about 8 cm, or any range or subrange therebetween.

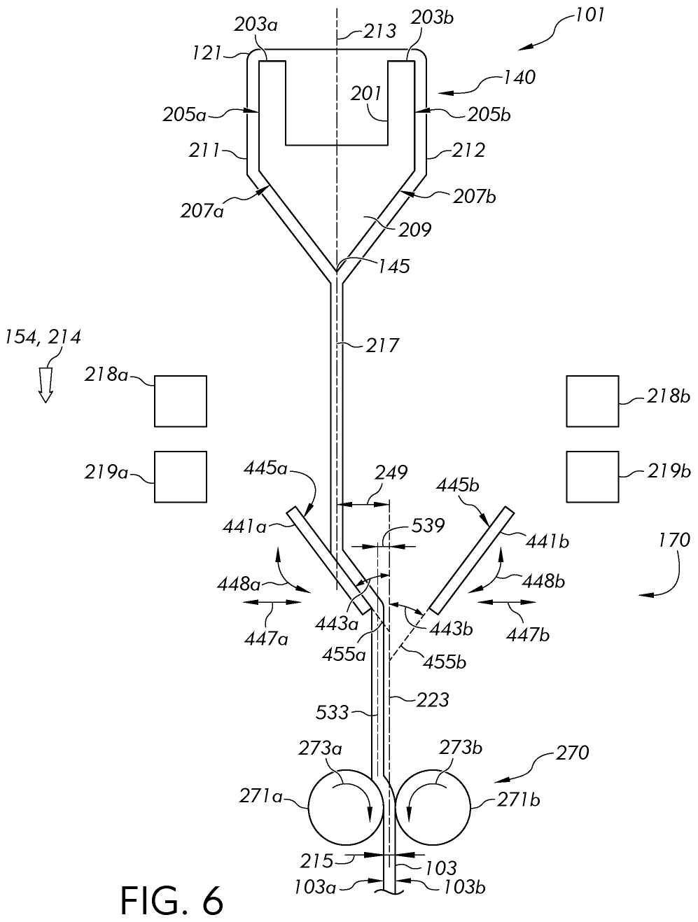

As shown in FIGS. 2-6, the glass manufacturing apparatus 100 comprises a guide member 170. As shown, the guide member 170 is positioned opposite the first roller 231 from the forming device 140 such that the guide member 170 is positioned downstream from the forming device 140 and the first roller 231, if present. For example, as shown in FIGS. 2-3 and 5, the guide member 170 can comprise at least one guide roller (e.g., a pair of guide rollers 241a and 241b). In further aspects, as shown in FIGS. 4 and 6, the guide member 170 can comprise at least one inclined plate (e.g., a pair of inclined plates 441a and 441b). Although two guide members (e.g., guide rollers 241a and 241b or inclined plates 441a and 441b) are shown for the guide member 170, a single guide member or more than two guide members may be provided in further aspects. Although not shown, the guide member can comprise a mixture of guide rollers and inclined plates, for example, with a guide roller intersected by the first axis paired with an inclined plate. It is to be understood that a discussion of features of the guide roller 241a can apply equally to the second guide roller 241b and features of the inclined plate 441a can apply equally to the second inclined plate 441b, unless indicated otherwise. Providing the guide member between the first roller and the pair of pull rollers can catch and/or redirect any portion of the stream of molten material that deviates from a second axis that the stream of molten material is configured to travel along during normal operation, which can prevent damage from such portion of the stream of molten material to other equipment in the glass manufacturing apparatus.

As shown in FIGS. 2-3 and 5, the guide member 170 can comprise at least a first guide roller 241a that is intersected by the first axis 213 but not the second axis 223. Consequently, as shown in FIG. 2, the stream 217 of molten material 121 traveling along the second axis 223 may not contact the first guide roller 241a. In aspects, as shown in FIGS. 2-3 and 5, a radial center 246a of the first guide roller 241a can be 120% of the first radius 237 of the first roller 231 or less from the first axis 213. For example, as shown in FIG. 2, a third distance 259 between the radial center 246a of the first guide roller 241a and the first axis 213 is less than 120% of the first radius 237 of the first roller 231, and, as shown in FIG. 3, the third distance 259 between the radial center 246a of the first guide roller 241a and the first axis 213 can be substantially zero (i.e., the first axis 213 intersects the radial center 246a of the first guide roller 241). In further aspects, the third distance 259 between the radial center 246a of the first guide roller 241a and the first axis 213 can be about 120% of the first radius 237 or less, about 110% of the first radius 237 or less, about 105% of the first radius 237 or less, about 100% of the first radius 237 or less, about 50% of the first radius 237 or less, about 20% of the first radius 237 or less, or about 10% of the first radius 237 or less. As shown in FIGS. 2-3, the second axis 223 can pass within the first radius 237 of a peripheral surface 245a of the first guide roller 241a, for example, a minimum distance 242a between the peripheral surface 245a of the first guide roller 241a and the second axis 223 can be less than the first radius 237. Further, the second axis 223 can pass within the first radius 237 of the peripheral surface 245a of the first guide roller 241a without the second axis 223 intersecting the first guide roller 241a. The minimum distance 242a between the peripheral surface 245a of the first guide roller 241a and the second axis 223 can be adjustable as indicated by arrows 248a, for example, with the minimum distance 242a being reduced from the configuration shown in FIG. 2 to achieve the configuration shown in FIG. 3.

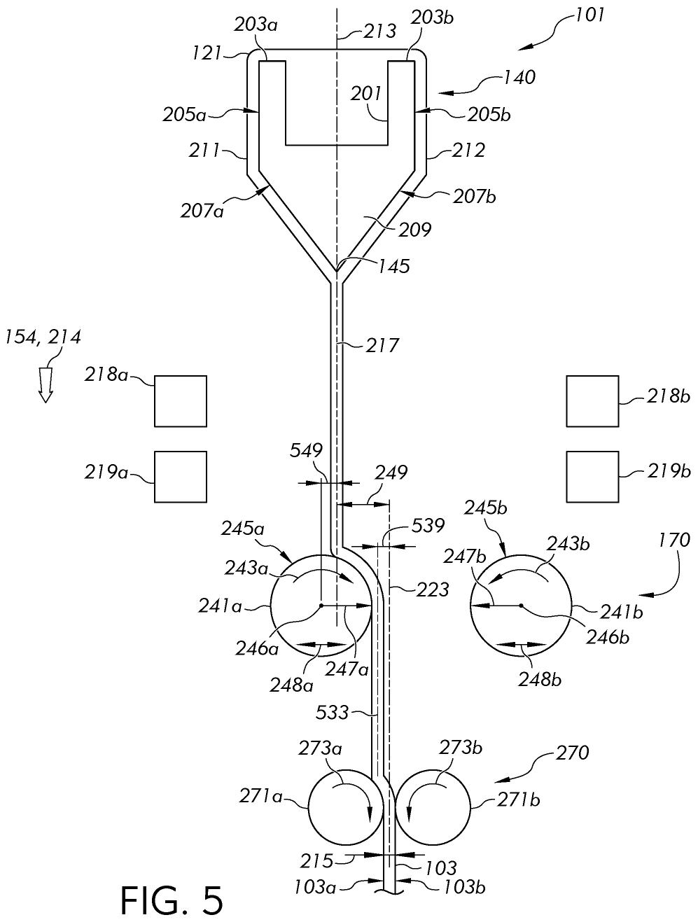

As shown in FIGS. 2-3, the first guide roller 241a can be configured to rotate in a direction 243a (e.g., clockwise in the illustrated side view) about the radial center 246a of the first guide roller 241a. For example, an upper peripheral portion 254a of the first guide roller 241a rotates in the direction 243a towards the second axis 223. Further, as shown in FIG. 3, the first guide roller 241a can be coupled to a motor 353a that rotates the first guide roller 241a in the direction 243a, for example, at a constant speed or a variable speed. Rotating the first guide member can reduce scattering of molten material, which reduces the risk of damage to other equipment and increases an efficiency of the method of making a glass ribbon. Although not shown in FIGS. 2 and 5, the first guide roller can be coupled to a motor as shown in FIG. 3. In aspects, a second radius 247a of the first guide roller 241a can range from about 3 cm to about 10 cm, from about 5 cm to about 8 cm, or any range or subrange therebetween. For example, the second radius 247a can be substantially equal to the first radius 237. As shown in FIGS. 2-3, a second distance 239 in the travel direction 154 between a radial center 236 of the first roller 231 and the radial center 246a of the first guide roller 241a can range from about 10 cm to about 50 cm, from about 15 cm to about 40 cm, from about 20 cm to about 30 cm, or any range or subrange therebetween.

The first guide roller 241a can be configured to cool the stream 217 of molten material 121 traveling along the second axis 223. For example, in the configuration shown in FIG. 2, the first guide roller 241a can radiatively cool the stream 217 of molten material 121 while, in the configuration shown in FIG. 3, the first guide roller 241a can further cool the stream 217 of molten material 121 by conduction when the molten material 121 contacts the peripheral surface 245a of the first guide roller 241a. In aspects, as shown in FIG. 2, the first guide roller 241a can be configured to receive a cooling fluid (as indicated by arrow 256a) therethrough, for example, from a conduit 253a. The cooling fluid can maintain a temperature of the peripheral surface 245a of the first guide roller 241a, which can effectively cool the stream 217 of molten material 121. For example, the peripheral surface 245a of the first guide roller 241a can be maintained at a temperature of about 200° C. or less, about 180° C. or less, or about 150° C. or less, which can mitigate sticking of molten material that comes into contact with the peripheral surface of the first guide roller. Throughout the disclosure, “effectively cooling” the stream of molten material means that there is a high heat flux (from the stream of molten material to the glass manufacturing apparatus) (e.g., about 10 kilo Watts per meters squared of ribbon of molten material (kW/m²) or more, about 20 kW/m² or more, about 30 kW/m² or more, about kW/m² or more) that reduces the temperature of the ribbon of molten material.

Effectively cooling the stream of molten material with the first roller and the guide member (e.g., at least one guide roller) can enable the use of a stream of molten material comprising a lower viscosity when the stream of molten material leaves a delivery device, for example, the use of molten material comprising a low devitrification viscosity (e.g., about 30,000 Pa-s or less, about 20,000 Pa-s or less) and/or a high devitrification temperature (e.g., about 750° C. or more, about 800° C. or more) to form a glass ribbon. Throughout the disclosure devitrification refers to the crystallization of material. As used herein, a devitrification viscosity is the lowest viscosity at which a material can devitrify at 1 atmosphere, and a devitrification temperature is the highest temperature at which a material at 1 atmosphere can devitrify. For example, the molten material may comprise a low viscosity when the molten material comprises a low devitrification viscosity (e.g., about 20,000 Pa-s or less, about 10,000 Pa-s or less, or about 8,000 Pa or less) and/or a high devitrification temperature (e.g., about 800° C. or more, or about 1,000° C. or more, or about 1,200° C. or more). In further aspects, the cooling fluid can comprise one or more of the states of matter and/or materials discussed above for the cooling fluid with reference to the first roller. Although not shown in FIGS. 3 and 5, the cooling fluid can be used to cool the first guide roller as shown in FIG. 2.

Also, the guide member 170 can further comprise a second guide roller 241b positioned on an opposite side of the stream 217 of molten material 121 from the first guide roller 241a, which can evenly cool and effectively cool (as defined above) the stream 217 of molten material 121. As used herein, “evenly cooling” means that differences in a local heat flux centered at different points along the width of ribbon of molten material is low (e.g., about 30% of the average heat flux or less, about 20% of the average heat flux less, about 10% of the average heat flux or less). For example, as shown in FIGS. 2 and 3, the second axis 223 can pass between the pair of guide rollers 241a and 241b. In aspects, the second guide roller 241b can comprise a radius 247b within one or more of the ranges for the second radius 247a and/or substantially equal to the second radius 247a. As shown in FIGS. 2-3, the second guide roller 241b can be configured to rotate in a direction 243b (e.g., counterclockwise in the illustrated side view) about a radial center 246b of the second guide roller 241b opposite the direction 243a (e.g., clockwise in the illustrated side view) that the first guide roller 241a can be configured to rotate about the radial center 246a of the first guide roller 241a. For example, an upper peripheral portion 254b of the second guide roller 241b rotates in the direction 243b towards the second axis 223. Further, as shown in FIG. 3, the second guide roller 241b can be coupled to a motor 353b that rotates the second guide roller 241b in the direction 243b, for example, at a constant speed or a variable speed. Rotating the second guide member can reduce scattering of molten material, which reduces the risk of damage to other equipment and increases an efficiency of the method of making a glass ribbon. Although not shown in FIGS. 2 and 5, the second guide roller can be coupled to a motor as shown in FIG. 3. In aspects, as shown in FIG. 2, the second guide roller 241b can be configured to receive a cooling fluid (as indicated by arrow 256b) therethrough, for example, from a conduit 253b. The cooling fluid can maintain a temperature of the peripheral surface 245b of the second guide roller 241b, which can be substantially equal to the temperature that the peripheral surface 245a the first guide roller 241a can be maintained at. In further aspects, the cooling fluid can comprise one or more of the states of matter and/or materials discussed above for the cooling fluid with reference to the first roller. Although not shown in FIGS. 3 and 5, the cooling fluid can be used to cool the first inclined plate as shown in FIG. 2.

A minimum distance 242b between the peripheral surface 245b of the second guide roller 241b and the second axis 223 can be substantially equal to the minimum distance 242a such that the second axis 223 bisects a nip distance 244 (i.e., a minimum distance between the peripheral surfaces 245a and 245b of the guide rollers 241a and 241b). The minimum distances 242a and 242b can be adjusted (as indicated by arrows 248a and 248b) to adjust the nip distance 244 and an extent of cooling provided by the guide rollers 241a and 241b to the stream 217 of molten material 121.

In aspects, the nip distance 244 shown in FIG. 2 can be reduced to a nip distance 344 shown in FIG. 3. For example, the nip distance 344 can be substantially equal to the thickness 215 between a first major surface 103a and a second major surface 103b opposite the first major surface 103a of the resulting glass ribbon 103 (e.g., within about 1 mm or less, about 5 mm or less, or about 10 mm or less). As shown in FIG. 3, the nip distance 344 can be small enough to form an intermediate ribbon 303 of molten material 121 comprising a thickness substantially equal to the nip distance 344. In aspects, as shown in FIG. 3, the nip distance 344 can be configured to form a pool 341 of molten material 121 above a nip area 342 corresponding to the location of the nip distance 344, which can be used to produce a stable (see the definition of “stability” above) and/or uniform intermediate ribbon of molten material. As used herein, “uniformity” refers to differences between local thicknesses of a cross-section of the intermediate ribbon in a plane perpendicular to the travel direction at different locations along the width of the intermediate ribbon with a “uniform” intermediate ribbon having substantially no deviations in local thickness across the width of the cross-section of the intermediate ribbon. The pool 341 of molten material 121 is supported by the pair of guide rollers 241a and 241b. Forming an intermediate ribbon of molten material can reduce deviations of any portion of the molten material from the second axis and/or increase a distance that the molten material (e.g., stream, ribbon) can travel without being destabilized.

As shown in FIGS. 4 and 6, the guide member 170 can comprise at least a first inclined plate 441a that is intersected by the first axis 213 but not the second axis 223. Consequently, as shown in FIG. 4, the stream 217 of molten material 121 traveling along the second axis 223 may not contact the first inclined plate 441a. In aspects, as shown in FIGS. 4 and 6, a cross-sectional center 446a of the first inclined plate 441a (i.e., center of the cross-section shown in FIGS. 4 and 6) can be within 120% of the first radius 237 of the first roller 231 from the first axis 213 (or within one or more of the narrower ranges discussed above for the third distance 259). For example, as shown in FIG. 4, the third distance 449 between the cross-sectional center 446a of the first inclined plate 441a and the first axis 213 is less than 120% of the first radius 237 of the first roller 231. As shown in FIG. 4, a distance 439 in the travel direction 154 between the radial center 236 of the first roller 231 and the cross-sectional center 446a of the first inclined plate 441a can be within one or more of the ranges discussed above for the second distance 239.

As shown in FIG. 4, the second axis 223 can pass within the first radius 237 of a contact surface 445a of the first inclined plate 441a, for example, a minimum distance 442a between the contact surface 445a of the first inclined plate 441a and the second axis 223 can be less than the first radius 237. Further, the second axis 223 can pass within the first radius 237 of the contact surface 445a of the first inclined plate 441a without intersecting the first inclined plate 441a. Also, a distance 459 between an outer periphery 451a of the contact surface 445a and the second axis 223 can be greater than the first radius 237 of the first roller 231, for example, about twice the first radius 237 or more, which can redirect molten material flowing off the other side 238a of the first roller 231. In aspects, as shown in FIG. 4, a projected width 456 of the first inclined plate 441a can be equal to or greater than the first radius 237, wherein the projected width 456 is defined between the outer periphery 451a and an inner periphery 457a of the first inclined plate 441a in a direction 404 of the first radius 237 that is perpendicular to the travel direction 154. In further aspects, the projected width 456 of the first inclined plate 441a can be equal to or greater than twice the first radius 237. The minimum distance 442a between the contact surface 445a of the first inclined plate 441a and the second axis 223 and/or the distance 459 can be adjustable as indicated by arrows 447a. Adjusting the minimum distance 442a can adjust an extent of cooling provided by the inclined plate 441a to the stream 217 of molten material 121.

The first inclined plate 441a can be configured to cool (e.g., radiatively cool) the stream 217 of molten material 121 traveling along the second axis 223. In aspects, as shown in FIG. 4, the first inclined plate 441a can be configured to receive a cooling fluid (as indicated by arrow 454a) therethrough, for example, from a conduit 453a. The cooling fluid can maintain a temperature of the contact surface 445a of the first inclined plate 441a, which can effectively cool the stream 217 of molten material 121 (as defined above). For example, the contact surface 445a of the first inclined plate 441a can be maintained at a temperature of about 200° C. or less, about 180° C. or less, or about 150° C. or less, which can mitigate sticking of molten material that comes into contact with the contact surface of the first inclined plate. Effectively cooling the stream of molten material can reduce the time and/or space required for the stream of molten material to sufficiently cool such that it can be handled in subsequent processing. Effectively cooling the stream of molten material can enable the use of a stream of molten material comprising a lower viscosity (e.g., about 5,000 Pascal-seconds or less, about 1,000 Pascal-seconds or less) when the stream of molten material leaves a delivery device, for example, the use of molten material comprising a low devitrification viscosity and/or a high devitrification temperature (defined above) to form a glass ribbon. In further aspects, the cooling fluid can comprise one or more of the states of matter and/or materials discussed above for the cooling fluid with reference to the first roller. Although not shown in FIG. 6, the cooling fluid can be used to cool the first inclined plate as shown in FIG. 4.

As shown in FIGS. 4 and 6, the contact surface 445a of the first inclined plate 441a can be downwardly inclined in the direction 214 of gravity toward the second axis such that the inner periphery 457a is closer to the second axis 223 and at a lower elevation than the outer periphery 451a. In aspects, as shown, the contact surface 445a can comprise a flat contact surface extending along a plane 455a. As used herein, an inclination angle of an inclined plate comprising a contact surface is defined as an interior angle formed at an intersection of a plane that a contact surface extends along and the second axis 223. For example, with reference to FIG. 4, an inclination angle 443a of the first inclined plate 441a is defined as an interior angle formed at an intersection of the plane 455a and a second axis 223. The inclination angle 443a can be about 5° or more, about 15° or more, about 20° or more, about 45° or less, about 35° or less, or about 25° or less. In aspects, the inclination angle 443a can range from about 5° to about 45°, from about 15° to about 35°, from about 20° to about 25°, or any range or subrange therebetween. Providing an inclination angle within one or more of the above-mentioned ranges can enable molten material contacting the contact surface to be directed off of the contact surface, for example, under the force of gravity. As shown in FIGS. 4 and 6, an inclination (e.g., inclination angle 443a) of the first inclined plate 441a can be adjusted as shown by arrows 448a, which can change an extent of cooling from the inclined plate 441a to the stream 217 of molten material 121.

Also, the guide member 170 can further comprise a second inclined plate 441b positioned on an opposite side of the stream 217 of molten material 121 from the first inclined plate 441a, which can evenly and effectively cool the stream 217 of molten material 121 (as defined above). For example, as shown in FIG. 4, the second axis 223 can pass between the pair of inclined plates 441a and 441b. As shown, the second inclined plate 441b comprises a contact surface 445b that can be downwardly inclined in the direction 214 of gravity toward the second axis such that an inner periphery 457b is closer to the second axis 223 and at a lower elevation than an outer periphery 451b shown in FIG. 4. In aspects, as shown, the contact surface 445b can comprise a flat contact surface extending along a plane 455b. As shown, an inclination angle 443b of the second inclined plate 441b is defined as an interior angle formed at an intersection of the plane 455b and the second axis 223, which can be within one or more of the ranges discussed above for the inclination angle 443a and/or be substantially equal to the inclination angle 443a. In aspects, an inclination (e.g., inclination angle 443b) of the second inclined plate 441b can be adjusted as shown by arrows 448b. A minimum distance 442b between the contact surface 445b of the second inclined plate 441b and the second axis 223 can be substantially equal to the minimum distance 442a, for example, such that a minimum distance 444 between the contact surface 445a of the first inclined plate 441a and the contact surface 445b of the second inclined plate 441b is bisected by the second axis 223. The minimum distance 442b between the contact surface 445b of the second inclined plate 441b and the second axis 223 can be adjustable as indicated by arrows 447b. For example, the minimum distance 442a and 442b can be adjusted (as indicated by arrows 447a and 447b) together to adjust the minimum distance 444 and to adjust an extent of cooling provided by the inclined plates 441a and 441b to the stream 217 of molten material 121. Adjusting the minimum distance 442a and/or 442b and/or the minimum distance 444 can adjust an extent of cooling provided by the inclined plate 441a to the stream 217 of molten material 121. In aspects, as shown in FIG. 4, the second inclined plate 441b can be configured to receive a cooling fluid (as indicated by arrow 454b) therethrough, for example, from a conduit 453b. The cooling fluid can maintain a temperature of the contact surface 445b of the second inclined plate 441b, which can be within one or more of the ranges discussed above and/or substantially equal to the temperature that the contact surface 445a the first inclined plate 441a can be maintained at. In further aspects, the cooling fluid can comprise one or more of the states of matter and/or materials discussed above for the cooling fluid with reference to the first roller. Although not shown in FIG. 6, the cooling fluid can be used to cool the second inclined plate as shown in FIG. 4.

In aspects, as shown in FIGS. 2-6 the glass-forming apparatus 101 can comprise one or more heating devices 218a and/or 218b. As shown in FIGS. 2-4, the one or more heating devices 218a and/or 218b can be positioned at about the same elevation as the first roller 231 (relative to the direction 214 of gravity), although the one or more heating devices 218a and/or 218b could be positioned at an elevation between the forming device 140 and the first roller 231 in other aspects. Providing the one or more heating devices can reduce an incidence of devitrification of molten material before it is directed off the first roller. In further aspects, the one or more heating devices 218a and/or 218b can comprise electrical resistance heaters or radiators configured to receive a flow of heating fluid (e.g., steam) therethrough.

In aspects, as shown in FIGS. 2-6, the glass-forming apparatus 101 can optionally comprise one or more cooling devices 219a and/or 219b. As shown in FIGS. 2-4, the one or more cooling devices 219a and/or 219b can be positioned between the first roller 231 and the guide member 170. Further, as shown, the one or more cooling devices 219a and/or 219b can be positioned farther from the second axis 223 than guide member 170. The one or more cooling devices 219a and/or 219b can radiatively cool the stream of molten material 121.

In aspects, as shown in FIGS. 2-6, the glass-forming apparatus 101 can comprise a pair of driven pull rollers 270 positioned downstream from the guide member 170. As shown, the pair of driven pull rollers 270 can comprise a first driven pull roller 271a and a second driven pull roller 271b with the second axis 223 passing therebetween. The first driven pull roller 271a can be configured to rotate in a direction 273a (e.g., clockwise in the illustrated side view), which can be the same as the direction 233 and/or the first guide roller 241a (see FIGS. 2-3 and 5). The second driven pull roller 271b can be configured to rotate in a direction 273b (e.g., counterclockwise in the illustrated side view) opposite the direction 273a of the first driven pull roller 271a. Further, as shown in FIG. 3, the first driven pull roller 271a can be coupled to a motor 275a that rotates the first driven pull roller 271a in the direction 273a, for example, at a constant speed or a variable speed, and/or the second driven pull roller 271b can be coupled to a motor 275b that rotates the second driven pull roller 271b in the direction 273b, for example, at a constant speed or a variable speed. The pair of driven pull rollers 270 can contact the stream 217 (see FIGS. 2 and 4-6) or intermediate ribbon 303 (see FIG. 3) of molten material 121. In aspects, the pair of driven pull rollers 270 can form a ribbon of molten material 121 comprising the thickness 215 that can be cooled to form the glass ribbon 103.

Methods of manufacturing a glass ribbon 103 from a stream of molten material 121 will now be described. Referring to FIGS. 2-4, the forming device 140 can deliver the stream 217 of molten material 121 to the first roller 231 by traveling along the first axis 213 in the travel direction 154 (e.g., direction 214 of gravity). Although not shown, the stream of molten material can comprise an elongated stream, for example, extending along a length of the forming device (e.g., in a direction into the page as shown in the figures) and/or a length of the first roller (e.g., perpendicular to the first radius 237 in a direction into the page).

As used herein, an average viscosity is measured using ASTM C965-96(2017) when the molten material is above the softening point or using ASTM C1351M-96(2017) when the molten material is below the softening point. For example, the viscosity can be determined by measuring the viscosity using one of the above-mentioned ASTM standards when a sample of the molten material is heated to the average temperature of the molten material at the corresponding location. As used herein, the average temperature is measured using ASTM E1256-17 or ASTM E2758-15, for example, using an Optris PI 640 infrared camera. An average viscosity of the stream 217 of molten material 121 leaving the forming device 140 can be substantially equal to the average viscosity of the stream 217 of molten material 121 at the root 145. In aspects, an average viscosity of the stream 217 of molten material 121 at the root 145 can be about 10 Pascal-seconds (Pa-s) or more, about 50 Pa-s or more, about 100Pa-s or more, about 200 Pa-s or more, about 400 Pa-s or more, about 5,000 Pa-s or less, about 2,000 Pa-s or less, about 1,000 Pa-s or less, about 800 Pa-s or less, or about 600 Pa-s or less. In aspects, the average viscosity of the stream 217 of molten material 121 at the root 145 can range from about 10 Pa-s to about 5,000 Pa-s, from about 50 Pa-s or more to about 2,000 Pa-s, from about 100 Pa-s to about 1,000 Pa-s, from about 200 Pa-s to about 800 Pa-s, from about 400 Pa-s to about 600 Pa-s, or any range or subrange therebetween. Providing the first roller and/or the guide members can enable the formation of glass ribbons from molten material comprising a low viscosity (e.g., within one or more of the ranges discussed above) by effectively cooling the stream of molten material (as defined above) so that it can be formed into the glass ribbon in subsequent processing.

Methods can comprise cooling the stream 217 of molten material 121 using at least the first roller 231. As shown in FIGS. 2-4, the first roller 231 contacts the stream 217 of molten material 121, and this contact can enhance a cooling effect by the first roller 231 on the stream 217 of molten material 121. For example, as shown in FIG. a cooling fluid (as indicated by arrow 252) can be flowed within the first roller 231 to maintain the first roller 231 at a predetermined temperature, which can cool the stream 217 of molten material 121 (e.g., radiatively cool) passing near the first roller 231 and/or cool a portion of the stream 217 of molten material 121 (e.g., conductively cool) contacting the peripheral surface 235 of the first roller 231. As shown, the first roller 231 can rotate in the direction 233, which can further cool the stream 217 of molten material 121 while directing the stream 217 of molten material 121 off the one side 238b of the first roller 231 such that the stream 217 of molten material 121 travels along the second axis 223. Further, as shown in FIG. 2, the entire stream 217 of molten material 121 can be directed off one side 238b of the first roller 231 (i.e., without directing molten material off the other side 238a). Also, the cooling devices 219a and/or 219b, if present, can cool the stream 217 of molten material 121 traveling along the second axis 223 and/or can facilitate cooling of the first roller 231.

As shown in FIGS. 2-6, methods can comprise cooling the stream 217 of molten material 121 with the guide member 170. For example, the guide member can radiatively cool the stream 217 of molten material 121. Without wishing to bound by theory, a radiative cooling rate can be proportional to a difference in temperature raised to the fourth power such that decreasing a temperature of the guide member can increase the cooling of the stream of molten material. The guide member 170 (e.g., peripheral surfaces 245a and 245b of the guide rollers 241a and 241b, and/or contact surfaces 445a and 445b of the inclined plates 441a and 441b) can be maintained at a temperature of about 200° C. or less, about 180° C. or less, or about 150° C. or less, for example, by flowing a cooling fluid (as indicated by arrows 256a, 256b and/or 454a, 454b in FIGS. 2 and 4). Also, maintaining the guide member at the temperature can mitigate sticking of molten material that comes into contact with the peripheral surface of the first guide roller. In aspects, an extent of cooling from the guide member 170 can be adjusted by adjusting a distance (e.g., minimum distance 242a, 242b, 442a, or 442b) between the guide member 170 (e.g., the guide rollers 241a and 241b or the inclined plates 441a and 441b) and the second axis 223 and/or, when the guide member comprises a pair of guide members, adjusting a distance (e.g., nip distance 244 or minimum distance 444) between the pair of guide members (e.g., guide rollers 241a and 241b or inclined plates 441a and 441b). Methods can comprise further cooling the stream 217 of molten material 121 to form the glass ribbon 103.

As shown in FIGS. 2-4, the stream 217 of molten material 121 can pass within the first radius 237 of the guide member 170. For example, as shown in FIGS. 2 and 4, the minimum distance 242a or 442a between the first guide roller 241a or the first inclined plate 441a and the second axis 223 that the stream 217 of molten material 121 travels along is less than the second distance 249 and/or the first radius 237. For example, as shown in FIG. 3, the nip distance 344 between the pair of guide rollers 241a and 241b can be substantially equal to a thickness of the intermediate ribbon 303 and/or the thickness 215 of the resulting glass ribbon 103, which is less than the first radius 237. For example, as shown in FIGS. 3 and 5-6, a portion of the stream 217 of molten material 121 can contact the guide member 170 (e.g., first guide roller 241a or first inclined plate 441a).

As shown in FIGS. 2-4, when the stream 217 of molten material 121 travels along the second axis 223, the stream 217 of molten material 121 and/or the second axis 223 do not intersect the guide member 170. However, as shown in FIGS. 2-6, the first axis 213 intersects the guide member 170. For example, the first axis 213 can intersect the first guide roller 241a (see FIGS. 2-3 and FIG. 5) or the first inclined plate 441a (see FIGS. 4 and 6). Providing a guide member intersecting the first axis can allow the glass manufacturing apparatus to compensate for a process upset (e.g., when the first roller is temporarily removed) and/or redirect at least a portion of the stream of molten material that deviates from the second axis. Redirecting at least a portion of the stream of molten material can reduce damage to other equipment with the molten material and/or allow the molten material to travel through subsequent parts of the glass manufacturing apparatus to produce a glass ribbon even during a process upset.

In aspects, as shown in FIGS. 2-3 and 5, the guide member 170 can comprise at least one guide roller 241a and/or 241b comprising a peripheral surface 245a and/or 245b, which can be maintained at a predetermined temperature by flowing a cooling fluid within the at least one guide roller, as indicated by arrows 256a and 256b in FIG. 2. The at least one guide roller 241a and/or 241b can rotate in the direction 243a and/or 243b such that the upper peripheral portion 254a and/or 254b rotates towards the second axis 223. Rotating the at least one guide roller can reduce scattering of molten material, which reduces the risk of damage to other equipment and increases an efficiency of the method of making a glass ribbon. In further aspects, as shown, the guide member 170 can comprise a pair of guide rollers 241a and 241b with the stream 217 of molten material 121 passing therebetween. In even further aspects, as shown in FIG. 3, the pair of guide rollers 241a and 241b can form the stream 217 of molten material 121 into an intermediate ribbon 303. For example, as shown, the stream 217 of molten material 121 can form the pool 341 of molten material 121 above the nip area 342 that is supported by the pair of guide rollers 241a and 241b, and molten material 121 can be drawn from the pool 341 of molten material 121 through the nip area 342 to form the intermediate ribbon 303 with a thickness corresponding to the nip distance 344 (i.e., the minimum distance between peripheral surfaces 245a and 245b of the pair of guide rollers 241a and 241b). Alternatively, in further aspects, the nip distance 244 between the pair of guide rollers 241a and 241b and/or a minimum distance 242a or 242b between the peripheral surface 245a or 245b of the guide roller 241a or 241a and the second axis 223 can be adjusted, as indicated by arrows 248a or 248b, to adjust the thickness of the intermediate ribbon 303 and/or to adjust the cooling of the stream 217 of molten material 121.

In aspects, as shown in FIGS. 4 and 6, the guide member 170 can comprise at least one inclined plate 441a and/or 441b comprising a contact surface 445a and/or 445b, which can be maintained at a predetermined temperature by flowing a cooling fluid within the at least one inclined plate, as indicated by arrows 454a and 454b in FIG. 4. The contact surface 445a and/or 445b of the at least one inclined plate 441a and/or 441b can comprise a flat contact surface and can be downwardly inclined in the direction of gravity toward the second axis with the inclination angle 443a and/or 443b. In further aspects, the guide member 170 can comprise a pair of inclined plates 441a and 441b with the stream 217 of molten material 121 passing therebetween. In even further aspects, the inclination angle 443a and/or 443b of the contact surface 445a and/or 445b can be adjusted, as indicated by arrows 448a and/or 448b, to adjust the cooling of the stream 217 of molten material 121. In even further aspects, the minimum distance 444 between the contact surfaces 445a and 445b of the pair of inclined plates 441a and 441b and/or a minimum distance 442a or 442b between the contact surface 445a or 445b of the inclined plate 441a or 441a and the second axis 223 can be adjusted, as indicated by arrows 447a or 447b, to adjust the cooling of the stream 217 of molten material 121.

As shown in FIGS. 2-6, methods can comprise passing the stream 217 of molten material 121 or the intermediate ribbon 303 of molten material 121 between the pair of driven pull rollers 270 to form the ribbon of molten material 121 that can be subsequently cooled into the glass ribbon 103. In aspects, an average viscosity of the molten material 121 as the molten material 121 passes between the pair of driven pull rollers 270 can be about 10⁴ Pa-s or more, about 2×10⁴ Pa-s or more, about 5×10⁴ Pa-s or more, about 10⁶ Pa-s or less, about 5×10⁵ Pa-s or less, or about 10⁵ Pa-s or less. In aspects, the average viscosity of the molten material 121 as the molten material 121 passes between the pair of driven pull rollers 270 can range from about 10⁴ Pa-s to about 10⁶ Pa-s, from about 2×10⁴ Pa-s to about 5×10⁵ Pa-s, from about 5×10⁴ Pa-s to about 10⁵ Pa-s, or any range or subrange therebetween.

In aspects, as shown in FIGS. 5-6, methods can comprise moving the first roller (not shown) out of contact with the stream 217 of molten material 121 such that the stream 217 of molten material 121 travels along the first axis 213 from the forming device 140 to the guide member 170. As shown, the molten material 121 traveling along the first axis 213 contacts the guide member 170, which directs the stream 217 of molten material to travel along a third axis 533. The third axis 533 extends in the travel direction 154 and/or the direction 214 of gravity and is parallel to the first axis 213 and the second axis 223. A fourth distance 539 (e.g., minimum distance) between the third axis 533 and the second axis 223 can be less than the first radius 237. For example, the third axis 533 is closer to the second axis 223 than the first axis 213 is to the second axis 223. In further aspects, the third axis 533 can be coincident with the second axis 223. In further aspects, as shown in FIG. 5, the guide member 170 can comprise at least one guide roller 241a and/or 241b, and the stream 217 of molten material 121 can contact the peripheral surface 245a of the at least one guide roller 241a, which directs the stream 217 of molten material 121 to travel along the third axis 533. In further aspects, as shown, the radial center 246a of the at least one guide roller 241a can be farther from the second axis 223 than the first axis 213 is from the second axis 223 by a distance 549 (e.g., about 5% or more, about 10% or more, or about 20% or more of the second radius 247a), which can direct substantially all (e.g., the entire) stream of the molten material 217 contacting the peripheral surface 245 off the side to flow along the third axis 533. In further aspects, as shown in FIG. 6, the guide member 170 can comprise at least one inclined plate 441a and/or 441b, and the stream 217 of molten material 121 can contact the contact surface 445a of the at least one inclined plate 441a, which directs the stream 217 of molten material 121 to travel along the third axis 533. During a process upset, for example when the first roller is temporarily removed and/or being replaced, providing the guide member 170 can redirect the stream 217 of molten material 121 to travel along a third axis 533 that is closer to the second axis 223 than the first axis 213 is to the second axis 223, which reduces the deviation of the stream of molten material from the second axis. Reducing the deviation of the stream 217 of molten material 121 using the guide member 170 can reduce damage to other equipment in the glass manufacturing apparatus. Reducing the deviation of the stream of molten material can allow the molten material to travel through subsequent parts of the glass manufacturing apparatus to produce a glass ribbon even during a process upset.

In further aspects, as shown in FIGS. 5-6, the stream 217 of molten material 121 can travel along the third axis 533 until it reaches the pair of driven pull rollers 270. In even further aspects, as shown, the third axis 533 can impinge the first driven pull roller 271a such that the stream 217 of molten material 121 traveling along the third axis 533 can be directed by the first driven pull roller 271a to travel along the second axis 223, for example, as it passes between the pair of driven pull rollers 270. In even further aspects, although not shown, the third axis 533 can be coincident with the second axis 223 such that the stream 217 of molten material 121 can pass between the pair of driven pull rollers 270. As discussed above, the pair of driven pull rollers 270 can form a ribbon of molten material 121 that can be cooled to form the glass ribbon 103.

Methods can comprise cooling the molten material 121 into the glass ribbon 103. In aspects, as shown in FIG. 1, the glass ribbon 103 can be divided into a plurality of glass sheets 104, which can be incorporated into various applications, for example electronic products. An electronic product, for example a consumer electronic product, may include a housing comprising a front surface, a back surface, and side surfaces; electrical components at least partially within the housing, the electrical components comprising a controller, a memory, and a display, the display at or adjacent the front surface of the housing; and a cover substrate disposed over the display, wherein at least one of a portion of the housing or the cover substrate comprises a glass article or a ceramic article formed from the glass ribbon described herein. The glass article or a ceramic article formed from the glass ribbon disclosed herein may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance or a combination thereof.

Aspects of the disclosure provide a guide member configured to cool a stream of molten material. An extent of cooling can be controlled by adjusting a distance between the guide member and the stream of molten material or an orientation of the guide member. Flowing a cooling fluid through the guide member can maintain a temperature at a surface of the guide member, which can effectively cool the stream of molten material. Also, the guide member can comprise a pair of guide members positioned on opposite sides of the stream of molten material, which can evenly cool and effectively cool the stream of molten material. Effectively cooling the stream of molten material can reduce the time and/or space required for the stream of molten material to sufficiently cool such that it can be handled, for example, using pull rollers. Effectively cooling the stream of molten material can enable the use of a stream of molten material comprising a lower viscosity (e.g., about 5,000 Pascal-seconds or less, about 1,000 Pascal-seconds or less) when the stream of molten material leaves a delivery device, for example, the use of molten material comprising a low devitrification viscosity and/or a high devitrification temperature (as defined above) to form a glass ribbon.

Aspects of the disclosure provide a first roller positioned between a delivery device and the guide member, where the first roller is configured to direct the stream off one side of the first roller. The first roller can be configured to cool the stream of molten material. In combination with the guide member, the first roller can further effectively cool the stream of molten material. Providing the guide member between the first roller and the pair of pull rollers can catch and/or redirect any portion of the stream of molten material that deviates from a second axis that the stream of molten material is configured to travel along during normal operation, which can prevent damage from such portion of the stream of molten material to other equipment in the glass manufacturing apparatus. When the guide member comprises a pair of guide members positioned on opposite sides of the stream of molten material, a distance between the pair of guide members can be adjusted, for example, such that the stream of molten material is formed into an intermediate ribbon of molten material by the pair of guide members (e.g., pair of guide rollers). Forming an intermediate ribbon of molten material can reduce deviations of any portion of the molten material from the second axis and/or increase a distance that the molten material (e.g., stream, ribbon) can travel without being destabilized. Further, the distance between a pair of guide rollers can form a pool of molten material above a nip between the pair of guide rollers, which can produce a stable and/or uniform intermediate ribbon of molten material. When the stream of molten material contacts a guide member, sticking of molten material to the guide member can be mitigated by maintaining a low temperature (e.g., about 200° C. or less) at a surface of the guide member.

During a process upset, for example when the first roller is temporarily removed and/or being replaced, the stream of molten material can travel along a first axis rather than a second axis. Providing the guide member can redirect the stream of molten material to travel along a third axis that is closer to the second axis than the first axis is to the second axis, which reduces the deviation of the stream of molten material from the second axis. Reducing the deviation of the stream of molten material can reduce damage to other equipment in the glass manufacturing apparatus. Reducing the deviation of the stream of molten material can allow the molten material to travel through subsequent parts of the glass manufacturing apparatus to produce a glass ribbon even during a process upset. When the guide member comprises at least one guide roller, rotating the at least one guide roller can reduce scattering of molten material, which reduces the risk of damage to other equipment and increases an efficiency of the method of making a glass ribbon.

As used herein, the terms “the,” “a,” or “an,” mean “at least one,” and should not be limited to “only one” unless explicitly indicated to the contrary. Thus, for example, reference to “a component” comprises aspects having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to comprise the specific value or endpoint referred to. If a numerical value or endpoint of a range in the specification recites “about,” the numerical value or endpoint of a range is intended to comprise two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other (e.g., within about 5% of each other, or within about 2% of each other).

As used herein, the terms “comprising” and “including,” and variations thereof, shall be construed as synonymous and open ended, unless otherwise indicated. A list of elements following the transitional phrases comprising or including is a non- exclusive list, such that elements in addition to those specifically recited in the list may also be present.

While various aspects have been described in detail with respect to certain illustrative and specific aspects thereof, the present disclosure should not be considered limited to such, as numerous modifications and combinations of the disclosed features are possible without departing from the scope of the following claims.

1. A glass manufacturing apparatus, comprising:
a forming device configured to deliver a stream of molten material to a first roller along a first axis extending in a direction of gravity, the first roller positioned downstream from the forming device and configured to direct the stream of molten material to flow off one side of the first roller and travel along a second axis extending in the direction of gravity and spaced a first distance within 20% of a radius of the first roller from the first axis; and
a guide member positioned downstream from the first roller, the first axis intersecting the guide member, and the second axis not intersecting the guide member.

2. The glass manufacturing apparatus of claim 1, further comprising a pair of driven pull rollers positioned downstream from the guide member, the second axis passing between the pair of driven pull rollers.

3. The glass manufacturing apparatus of claim 1, wherein the guide member comprises at least one guide roller, and a second distance between the first axis and a radial center of the at least one guide roller is 120% of the radius of the first roller or less.

4. The glass manufacturing apparatus of claim 3, wherein the first roller is configured to receive a flow of cooling fluid therethrough.

5. The glass manufacturing apparatus of claim 3, wherein the at least one guide roller is rotatable about an axis of rotation and coupled to a motor such that an upper peripheral portion of the at least one guide roller rotates toward the second axis when the at least one guide roller is rotated by the motor.

6. The glass manufacturing apparatus of claim 3, wherein a radius of the at least one guide roller is in a range from about 3 centimeters to about 10 centimeters.

7. The glass manufacturing apparatus of claim 3, wherein a distance along the second axis between a radial center of the first roller and the radial center of the at least one guide roller is in a range from about 10 centimeters to about 50 centimeters.

8. The glass manufacturing apparatus of claim 3, wherein the at least one guide roller comprises a pair of guide rollers, the second axis passing between the pair of guide rollers.

9. The glass manufacturing apparatus of claim 8, wherein a minimum distance between peripheral surfaces of the pair of guide rollers is adjustable.

10. The glass manufacturing apparatus of any one of claim 1, wherein the guide member comprises a contact surface that is downwardly inclined in the direction of gravity toward the second axis.

11. The glass manufacturing apparatus of claim 10, wherein the contact surface comprises a flat contact surface extending along a plane, and the plane of the flat contact surface intersects the second axis at an inclination angle in a range from about 5° to about 45°.

12. The glass manufacturing apparatus of claim 11, wherein the inclination angle of the contact surface is adjustable.

13. A method of forming a glass ribbon comprising:
contacting a first roller with a stream of molten material from a forming device, the stream of molten material comprising a first viscosity in a range from about 10 Pascal-seconds to about 5,000 Pascal-seconds when the stream of molten material leaves the forming device, the stream of molten material traveling along a first axis extending in a direction of gravity from the forming device to the first roller;
directing the stream of molten material with the first roller to flow off one side of the first roller and travel along a second axis extending in the direction of gravity, wherein a first distance between the first axis and the second axis is within 20% of a radius of the first roller; and
cooling the stream of molten material with a guide member.

14. The method of claim 13, wherein directing the stream of molten material comprises directing the entire stream of molten material to travel off the one side of the first roller.

15. The method of claim 13, wherein the first viscosity is in a range from about 100 Pascal-seconds to about 1,000 Pascal-seconds.

16. The method of claim 13, further comprising, after cooling the stream of molten material with the guide member, passing the stream of molten material between a pair of driven pull rollers to form a ribbon of molten material, and cooling the ribbon of molten material to form the glass ribbon.

17. The method of claim 16, wherein the stream of molten material passing between the pair of driven pull rollers comprises a second viscosity in a range from about 10⁴ Pascal-seconds to about 10⁶ Pascal-seconds.

18. The method of claim 13, further comprising maintaining the guide member at a temperature of about 200° C. or less during the cooling.

19. The method of claim 13, further comprising moving the first roller out of contact with the stream of molten material such that the stream of molten material travels along the first axis to the guide member and the guide member directs the stream of molten material to travel along a third axis in the direction of gravity, wherein a fourth distance between the third axis and the second axis is 120% of the radius of the first roller or less.

20. The method of claim 18, wherein the guide member comprises at least one guide roller, the at least one guide roller comprising a peripheral surface, and maintaining the at least one guide roller at the temperature by flowing a cooling fluid within the at least one guide roller.

21. The method of claim 20, further comprising rotating the at least one guide roller such that an upper peripheral portion of the at least one guide roller rotates toward the second axis.

22. The method of claim 20, wherein the at least one guide roller comprises a pair of guide rollers, and the stream of molten material passes between the pair of guide rollers to form an intermediate ribbon of molten material comprising a thickness substantially equal to a nip distance of a nip area between corresponding peripheral surfaces of the pair of guide rollers.

23. The method of claim 22, wherein the stream of molten material forms a pool of molten material supported by the pair of guide rollers above the nip area, and molten material is drawn from the pool of molten material through the nip area to form the intermediate ribbon of molten material.

24. The method of claim 20, further comprising adjusting a distance between the stream of molten material and the peripheral surface of the at least one guide roller to adjust the cooling of the stream of molten material.

25. The method of claim 18, wherein the guide member comprises at least one inclined plate, the method further comprising flowing a cooling fluid within the at least one inclined plate.

26. The method of claim 25, wherein the at least one inclined plate comprises a flat contact surface downwardly inclined in the direction of gravity toward the second axis and extending along a plane that intersects the second axis at an inclination angle in a range from about 5° to about 45°.

27. The method of claim 26, further comprising adjusting the inclination angle of the at least one inclined plate to adjust the cooling the stream of molten material.

28. The method of claim 25, wherein the guide member comprises a pair of inclined plates, and the stream of molten material passes between the pair of inclined plates.
